(19) United States
(12) Patent Application Publication
(10) Pub. No.: US 2007/0087175 A1
(43) Pub. Date: Apr. 19, 2007

(54) Wired circuit board

(75) Inventors: Naoto Iwasaki, Osaka (JP); Toshiki Naito, Osaka (JP)

Correspondence Address: AKERMAN SENTERFITT, 801 PENNSYLVANIA AVENUE N.W., SUITE 600, WASHINGTON, DC, 20004, US

(73) Assignee: Nitto Denko Corporation, Osaka (JP)

(21) Appl. No.: 11/636,997

(22) Filed: Dec. 12, 2006

Related U.S. Application Data
(62) Division of application No. 11/064,833, filed on Feb. 25, 2005.

(30) Foreign Application Priority Data
Feb. 27, 2004 (JP) JP 2004-053125

(51) Int. Cl. B32B 3/00

(52) U.S. Cl. 428/209; 428/901

(57) ABSTRACT

A wired circuit board is provided that includes an insulating base layer, a conductor layer formed on the insulating base layer, and an insulating cover layer formed on the conductor layer and having an opening through which the conductor layer is exposed, an electrode is formed on the surface of the conductor layer exposed through the opening by forming a nickel plating layer by electroless nickel plating, and then forming a gold plating layer on the nickel plating layer by electrolytic gold plating. Thus, the invention provides a wired circuit board having enhanced connection reliability and reduced cost of manufacture among other benefits.

### BACKGROUND OF THE INVENTION

1. Field of the Invention

The present invention relates to a wired circuit board, and more particularly, to a wired circuit board having electrodes.

2. Description of the Prior Art

A wired circuit board, such as a flexible wired circuit board, generally includes an insulating base layer, a conductor layer formed on the insulating base layer in the form of a wired circuit pattern, and an insulating cover layer formed on the conductor layer.

The insulating cover layer is generally provided with openings through which the conductor layer is exposed, and electrodes are provided onto the conductor layer exposed through the openings.

Electrodes comprising a nickel plating layer formed by electroless nickel plating and a gold plating layer formed sequentially on the nickel plating layer by electroless gold plating as are disclosed, for example, in Japanese Laid-open (Unexamined) Patent Publication No. 2000-188461, are known as such electrodes.

Recently, in order to enhance the connection reliability of the electrodes, there has been a need to form the electrodes at a low cost while making the thicknesses of the nickel plating layer and the gold plating layer even.

However, it takes so long to form the nickel plating layer and the gold plating layer, particularly the gold plating layer, by electroless plating as is disclosed in Japanese Laid-open (Unexamined) Patent Publication No. 2000-188461 supra that the cost is increased due to poor manufacturing efficiency.

The cost can be reduced by forming the nickel plating layer and the gold plating layer by electrolytic plating; however, this in turn makes the thicknesses of the nickel plating layer and the gold plating layer uneven.

### SUMMARY OF THE INVENTION

It is an object of the present invention to provide a new wired circuit board capable of enhancing the connection reliability and reducing the cost.

The present invention provides a wired circuit board, comprising an insulating base layer, a conductor layer formed on the insulating base layer, and an insulating cover layer formed on the conductor layer and having an opening through which the conductor layer is exposed, wherein a nickel plating layer formed by electroless nickel plating and a gold plating layer formed on the nickel plating layer by electrolytic gold plating are provided on a surface of the conductor layer exposed through the opening.

In the wired circuit board of the present invention, the electrode comprises the nickel plating layer formed by electroless nickel plating and the gold plating layer formed thereon by electrolytic gold plating. It is thus possible to reduce the cost by forming the gold plating layer efficiently while ensuring an even thickness by the nickel plating layer.

The present invention also provides a wired circuit board, comprising an insulating base layer, a conductor layer formed on the insulating base layer, and an insulating cover layer formed on the conductor layer and having an opening through which the conductor layer is exposed, wherein a nickel plating layer formed by electroless nickel plating, a first gold plating layer formed on the nickel plating layer by electroless gold plating and having a thickness in a range of 0.05-0.1 μm, and a second gold plating layer formed on the first gold plating layer by electrolytic gold plating are provided on a surface of the conductor layer exposed through the opening.

In the wired circuit board of the present invention, the electrode comprises the nickel plating layer formed by electroless nickel plating, the first gold plating layer formed thereon by electroless gold plating, and the second gold plating layer formed thereon by electrolytic gold plating. It is thus possible to reduce the cost by forming the second gold plating layer efficiently while not only ensuring an even thickness by the nickel plating layer, but also enhancing the adhesion between the nickel plating layer and the second gold plating layer by the first gold plating layer.

### BRIEF DESCRIPTION OF THE DRAWINGS

In the drawings:

FIG. 1 illustrates the production process detailing a method of producing a flexible wired circuit board according to a first embodiment of the present invention:

(a) shows the step of preparing an insulating base layer;

(b) shows the step of forming a conductor layer in the form of a wired circuit pattern on the insulating base layer;

(c) shows the step of forming an insulating cover layer having openings on the insulating base layer;

(d) shows the step of forming a nickel plating layer by electroless nickel plating on the surface of the conductor layer exposed through the openings; and

(e) shows the step of forming a gold plating layer by electrolytic gold plating on the nickel plating layer.

FIG. 2 illustrates the production process detailing a method of producing a flexible wired circuit board according to a second embodiment of the present invention:

(a) shows the step of preparing an insulating base layer;

(b) shows the step of forming a conductor layer in the form of a wired circuit pattern on the insulating base layer;

(c) shows the step of forming an insulating cover layer having openings on the insulating base layer;

(d) shows the step of forming a nickel plating layer by electroless nickel plating on the surface of the conductor layer exposed through the openings;

(e) shows the step of forming a first gold plating layer on the nickel plating layer by electroless gold plating; and

(f) shows the step of forming a second gold plating layer on the first gold plating layer by electrolytic gold plating.

### DESCRIPTION OF THE PREFERRED EMBODIMENTS

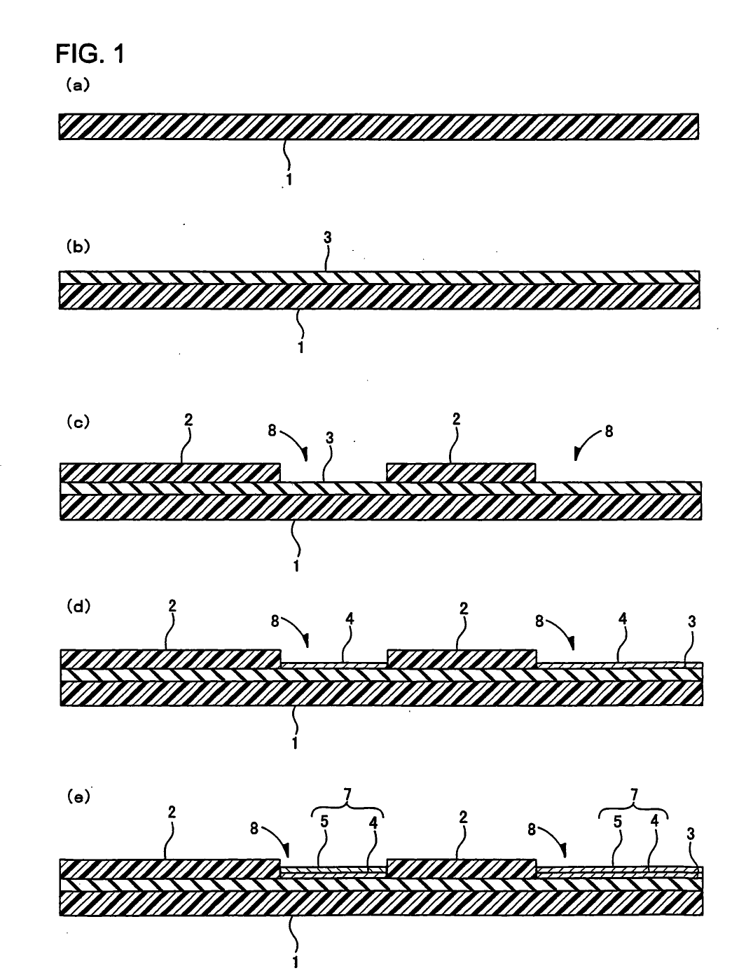

FIG. 1 illustrates the production process detailing a method of producing a flexible wired circuit board according to a first embodiment of the present invention.

Referring to FIG. 1, according to this method, an insulating base layer 1 is prepared first as is shown in FIG. 1(a). No particular limitation is imposed on the insulating base layer 1 as long as it has insulating properties and flexibility, and it comprises, for example, a resin film made of a polyimide resin, an acrylic resin, a polyether nitrile resin, a polyether sulfonic resin, a polyethylene terephthalate resin, a polyethylene naphthalate resin, a polyvinyl chloride resin, etc. Preferably, it comprises a polyimide resin film. A thickness of the insulating base layer 1 is in the range of e.g. 5-30 μm.

According to this method, as is shown in FIG. 1(b), a conductor layer 3 is formed next on the insulating base layer 1 in the form of a wired circuit pattern. No particular limitation is imposed on the conductor layer 3 as long as it has electrical conductivity, and it comprises, for example, a metal foil made of copper, chromium, nickel, aluminum, stainless, copper-beryllium, phosphor bronze, iron-nickel, alloys of the foregoing, etc. Preferably, it comprises a copper foil. A thickness of the conductor layer 3 is in the range of e.g. 3-25 μm.

A known patterning method, such as an additive process and a subtractive process, is used to form the conductor layer 3 in the form of the wired circuit pattern.

According to this method, an insulating cover layer 2 having openings 8 is formed next on the insulating base layer 1 to cover the conductor layer 3 that has been formed in the form of the wired circuit pattern.

The insulating cover layer 2 comprises the same resin film specified above, and it preferably comprises a polyimide resin film. The insulating cover layer 2 is formed, for example, by applying or printing a resin solution followed by drying and curing, or by laminating a resin film. Alternatively, it can be formed concurrently with the patterning by applying a solution of a photosensitive resin followed by exposure and development. A thickness of the insulating cover layer 2 is in the range of e.g. 2-15 μm.

For instance, in the case of printing the resin solution or the pattering of the photosensitive resin, the openings 8 can be formed concurrently when the insulating cover layer 2 is formed. In the case of applying the resin solution on the entire surface or laminating the resin film, they are formed by a known method, such as drilling, punching, laser machining, and etching.

The conductor layer 3 is exposed through the openings 8 formed in this manner.

According to this method, as is shown in FIG. 1(d), a nickel plating layer 4 is formed by electroless nickel plating on the surface of the conductor layer 3 exposed through the openings 8 made in the insulating cover layer 2. A thickness of the nickel plating layer 4 is in the range of e.g. 0.5-15 μm, or preferably 1.0-5.0 μm.

No particular limitation is imposed on the condition of electroless nickel plating to form the nickel plating layer 4, and for example, a known method using palladium catalyst is adopted.

According to this method, as is shown in FIG. 1(e), a gold plating layer 5 is formed next on the nickel plating layer 4 by electrolytic gold plating. A thickness of the gold plating layer 5 is in the range of e.g. 0.05-1.0 μm, or preferably 0.05-0.15 μm.

No particular limitation is imposed on the condition of electrolytic gold plating to form the gold plating layer 5, and for example, the subject is dipped in a plating bath, such as gold bond, for electrolytic gold plating to take place at a current in the range of 0.1-2.0 A, or preferably 0.3-1.0 A and at a temperature in the range of 40-75° C., or preferably 50-65° C. for 70-600 s, or preferably 80-100 s.

Electrodes 7, comprising the nickel plating layer 4 formed by electroless plating and the gold plating layer 5 formed on the nickel plating layer 4 by electrolytic plating, are thus formed on the surface of the conductor layer 3 exposed through the openings 8.

In the flexible wired circuit board according to the first embodiment, the electrodes 7 comprise the nickel plating layer 4 formed by electroless plating and the gold plating layer 5 formed by electrolytic plating. It is thus possible to reduce the cost by forming the gold plating layer 5 efficiently while ensuring an even thickness of the electrodes 7 by the nickel plating layer 4.

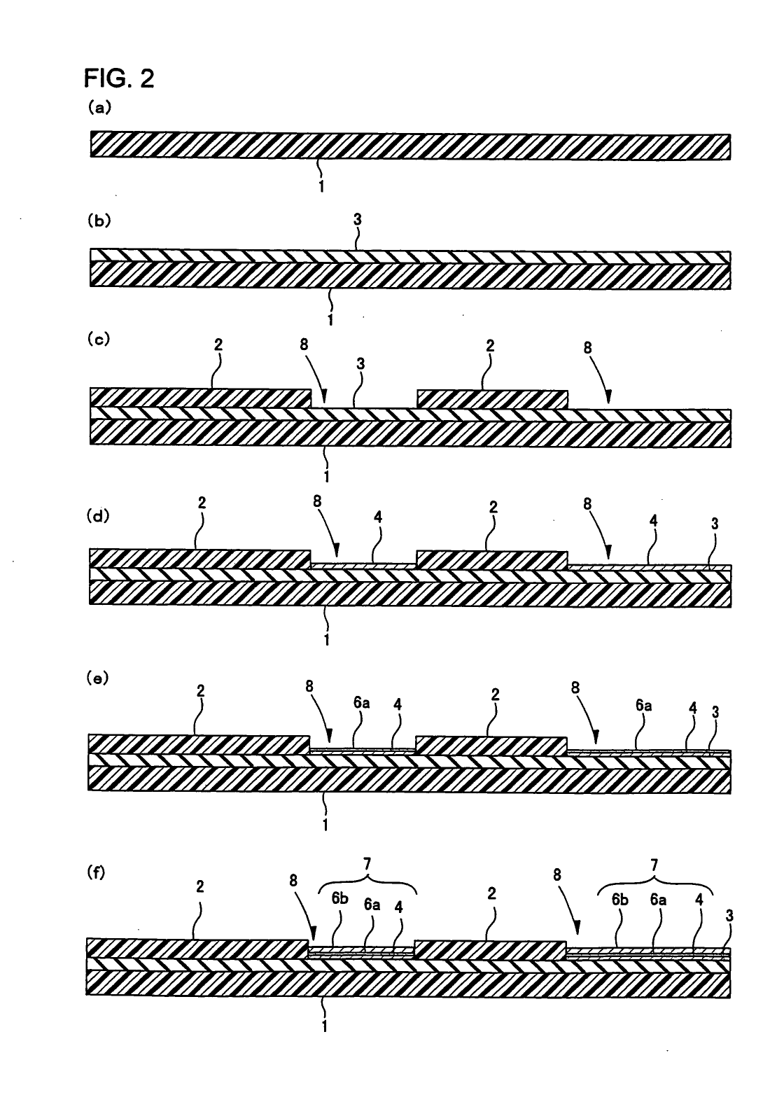

FIG. 2 illustrates the production process detailing a method of producing a flexible wired circuit board according to a second embodiment of the present invention. In FIG. 2, same numerals refer to same parts corresponding to the above, and the description thereof is omitted herein.

According to this method, the steps (Cf. FIGS. 2(a) through 2(d)) until the nickel plating layer 4 is formed on the exposed surface of the conductor layer 3 are performed in the same manner as with the method of producing the flexible wired circuit board of the first embodiment (Cf. FIGS. 1(a) through 1(d)).

According to this method, as is shown in FIG. 2(e), a first gold plating layer 6a is formed on the nickel plating layer 4 by electroless gold plating. A thickness of the first gold plating layer 6a is in the range of e.g. 0.03-0.12 μm, or preferably 0.05-0.1 μm.

No particular limitation is imposed on the condition of electroless gold plating to form the first gold plating layer 6a, and for example, the subject is dipped in a plating solution, such as gold potassium cyanide, for electroless gold plating to take place through a substitution reaction at a temperature in the range of 70-90° C., or preferably 75-88° C. for 300-600 s, or preferably 300-450 s.

According to this method, as is shown in FIG. 2(f), a second gold plating layer 6b is formed next on the first gold plating layer 6a by electrolytic gold plating. The second gold plating layer 6b can be formed in the same manner as the gold plating layer 5 described above, and a thickness thereof is in the range of e.g. 0.05-1.0 μm, or preferably 0.05-0.15 μm.

Electrodes 7, comprising the nickel plating layer 4 formed by electroless plating, the first gold plating layer 6a formed on the nickel plating layer 4 by electroless plating, and the second gold plating layer 6b formed on the first gold plating layer 6a by electrolytic gold plating, are thus formed on the surface of the conductor layer 3 exposed through the openings 8.

According to the flexible wired circuit board according to the second embodiment, the electrodes 7 comprise the nickel plating layer 4 formed by electroless plating, the first gold plating layer 6a formed by electroless plating, and the second gold plating layer 6b formed by electrolytic gold plating. It is thus possible to reduce the cost by forming the second gold plating layer 6b efficiently while not only ensuring an even thickness of the electrodes 7 by the nickel plating layer 4, but also enhancing the adhesion between the nickel plating layer 4 and the second gold plating layer 6b by the first gold plating layer 6a.

### EXAMPLES

The invention will now be described more concretely in examples and a comparative example below. It should be appreciated, however, that the invention is not particularly limited to the examples and the comparative example below.

### Example 1

An insulating base layer comprising a polyimide film having a thickness of 25 μm was prepared (Cf. FIG. 1(a)). A chromium thin film having a thickness of 1700 nm and a copper thin film having a thickness of 8000 nm were formed next sequentially on the insulating base layer by sputtering. Further, after a plating resist was formed in a reversal pattern with respect to the wired circuit pattern on the copper thin film, a conductor layer made of copper and having a thickness of 9 μm was formed by electrolytic copper plating in the form of the wired circuit pattern on the surface of the copper thin film exposed from the plating resist (Cf. FIG. 1(b)).

After the plating resist, the chromium deposited film, and the copper thin film were removed sequentially, a liquid photosensitive solder resist (product name: NPR-80/ID43, available from Nippon Polytech Corp.) was applied on the insulating base layer to cover the conductor layer, followed by exposure and development. An insulating cover layer having openings and a thickness of 12 μm was thus formed (Cf. FIG. 1(c)).

Subsequently, a nickel plating layer having a thickness of 1.2 μm was formed by electroless nickel plating on the surface of the conductor layer exposed through the openings (Cf. FIG. 1(d)). To be more specific, after palladium catalyst was adhered on the surface of the conductor layer, the subject was dipped in an electroless nickel plating solution using sodium hypophosphite as a reducing agent at 82° C. for 5 min. A nickel plating layer was thus formed.

Subsequently, a gold plating layer having a thickness of 0.1 μm was formed on the nickel plating layer by electrolytic gold plating (Cf. FIG. 1(e)). To be more specific, a plating bath of gold strike was kept at 50° C. and a current of 0.8 A was applied for 15 sec, and a plating bath of gold bond was kept at 63° C. and a current of 0.3 A was applied for 80 sec. A gold plating layer was thus formed.

A flexible wired circuit board was obtained through the steps described above.

### Example 2

A flexible wired circuit board was produced in the same manner as Example 1 above except that a first gold plating layer having a thickness of about 0.05 μm was formed through a substitution reaction (Cf. FIG. 2(e)) after the step of forming the nickel plating layer (Cf. FIG. 2(d)) and before the step of forming the gold plating layer (second gold plating layer) (Cf. FIG. 2(f)), by dipping the subject in an electroless gold plating solution containing gold potassium cyanide at 88° C. for 7 min.

### Comparative Example 1

A flexible wired circuit board was produced in the same manner as Example 1 above except that the nickel plating layer was formed by electrolytic nickel plating instead of forming the nickel plating layer by electroless nickel plating.

In electrolytic nickel plating, a plating bath of an electrolytic nickel plating solution chiefly comprising nickel sulfate/nickel chloride was kept at 50° C. and a current of 1.6 A was applied for 6 min.

Evaluation (Measurement of Thickness of Electrode)

The thickness of the nickel plating layer and the thickness of the gold plating layer (a sum of those of the first gold plating layer and the second gold plating layer) were measured with the use of an X-ray fluorescence plating thickness measuring instrument (product name: XRX-A-CL-D-XY, available from CMI International). The thicknesses of 45 electrodes were measured in each of Example 1, Example 2, and Comparative Example 1, and the average and the standard deviation were found for each.

In addition, a sum of the thickness of the nickel plating layer and the thickness of the gold plating layer thus measured was found as the thickness of an electrode. The average and the standard deviation of the thickness of the electrode were also found.

The results are set forth in TABLE 1 below.

TABLE 1

| | | Example- | | |
|---|---|---|---|---|
| | | Comparative Example | | |
| | | | | Comparative |
| | | Example 1 | Example 2 | Example 1 |
| Thickness of Ni | Average | 1.242 | 1.320 | 1.002 |
| Plating Layer (μm) | Standard | 0.051 | 0.032 | 0.357 |
| | Deviation | | | |
| Thickness of Au | Average | 0.110 | 0.103 | 0.117 |
| Plating Layer (μm) | Standard | 0.012 | 0.011 | 0.014 |
| | Deviation | | | |
| Thickness of | Average | 1.352 | 1.423 | 1.119 |
| Electrode (μm) | Standard | 0.063 | 0.043 | 0.371 |
| | Deviation | | | |

TABLE 1 reveals that the standard deviation (dispersion) of the thickness of the nickel plating layer and the standard deviation of the thickness of the electrode are small in Example 1 and Example 2 in comparison with Comparative Example 1.

While illustrative embodiments of the present invention are provided in the above description, such is for illustrative purpose only and is not to be construed restrictively. Modification and variation of the invention that will be obvious to those skilled in the art is to be covered by the following claims.

The disclosure of Japanese patent application Serial No. 2004-053125, filed on Feb. 27, 2004, is incorporated rein by reference.

1. (canceled)

2. (canceled)

3. A method of forming a wired circuit board comprising:
providing an insulating base layer;
providing a conductor layer formed on the insulating base layer;
providing an insulating cover layer formed on the conductor layer;
forming an opening in the insulating cover layer to expose the conductor layer;
providing, in the opening of the insulating cover layer, a nickel plating layer on the conductor layer formed by electroless nickel plating; and
providing, in the opening of the insulating cover layer, a gold plating layer on the nickel plating layer by electrolytic gold plating.

4. A method of forming a wired circuit board, comprising:
providing an insulating base layer;
providing a conductor layer formed on the insulating base layer;
providing an insulating cover layer formed on the conductor layer;
forming an opening in the insulating cover layer to expose the conductor layer;
providing, in the opening in the insulating cover layer, a nickel plating layer on the conductor layer formed by electroless nickel plating;
providing, in the opening in the insulating cover layer, a first gold plating layer on the nickel plating layer having a thickness in a range of 0.05-0.1 μm, by electroless gold plating; and
providing, in the opening in the insulating cover layer, a second gold plating layer on the first gold plating layer by electrolytic gold plating.
